(19) United States
(12) Patent Application Publication
(10) Pub. No.: US 2015/0144752 A1
(43) Pub. Date: May 28, 2015

(54) Multi-functional holders for bath and shower products

(71) Applicant: Linda Lim, Houston, TX (US)

(72) Inventor: Linda Lim, Houston, TX (US)

(21) Appl. No.: 14/544,252

(22) Filed: Dec. 15, 2014

Related U.S. Application Data
(63) Continuation-in-part of application No. 29/463,098, filed on Jul. 25, 2013, now Pat. No. D724346.
Application No. 29/463,098 is a continuation-in-part of application No. 29/463,096, filed on Jul. 25, 2013, now abandoned.
Application No. 29/463,096 is a continuation-in-part of application No. 29/463,097, filed on Jul. 25, 2013, now Pat. No. D724345.
(60) Provisional application No. 61/964,434, filed on Jan. 6, 2014.

(51) Int. Cl. F16B 47/00; F16M 13/02

(52) U.S. Cl. CPC F16B 47/00; F16M 13/022
USPC 248/206.3; 248/205.5

(57) ABSTRACT

The present invention relates to a solution for shower organization products. In one embodiment, the shower piece has a holder with a platform that has a suction cup on the back, a retainer attached to the front of the holder, wherein the platform has a hole, wherein the holder is designed to hold bottles without flattops upside-down. In another embodiment, the shower piece has a holder with a platform that has a suction cup on the back, two tabs on the sides of the platform of the holder, a retainer attached to the front of the holder, wherein the platform has a hole in the center of the platform, wherein the shower piece is designed to hold both flattop bottles that stand on their heads and traditional round top bottles upside-down. In another embodiment, the shower piece has a holder with a platform that has a suction cup on the back, two tabs on the sides of the platform of the holder, a retainer attached to the front of the holder, wherein the platform has a hole in the center of the platform. In this embodiment, the shower piece is able to grasps bottles with a waist while holding them upside-down and locked in place. In another embodiment, the shower piece has a holder with a platform and two small suction cups on the back, wherein the platform has a hole in the center of the platform, wherein the holder is able to hold traditional round top bottles upside-down.

### RELATED APPLICATIONS

The present application claims the benefit of patent provisional application Ser. No. 61/964,434, filed Jan. 6, 2014, and the present application is a continuation-in-part of design patent applications 29/463,098, filed Jul. 25, 2013, 29/463,096, filed Jul. 25, 2013, and 29/463,097, filed Jul. 25, 2013. The contents of each of these references are incorporated herein by reference and are not admitted to be prior art with respect to the present invention by the mention in this cross-reference section.

### FIELD OF THE INVENTION

The present invention is in the technical field of bathroom organization. More particularly, the present invention is in the technical field of shower organization products.

### BACKGROUND OF THE INVENTION

1. Description of the Prior Art

Typically, shower organization devices include shower caddies and shower shelving units. A shower caddy is usually a permanent or semi-permanent device that sits on the floor of the bath or shower, hangs from the showerhead, or in some cases is attached to the wall using suction cups. Some shower-shelving units stand along the lip of the tub and are held in place using a tension rod, which presses against both the ceiling and the lip of the tub. A shower caddy has different spaces, which are intended to hold certain types of personal care products one would use in the shower. For example, there are hooks to hang washcloths, holders to hang razors, racks and dishes to set bars of soap, and shelves to hold bottles of shampoo or other personal care products.

The problems associated with these shower organization products are that because shower caddies are hung on the showerhead, they are therefore located behind the stream of water, making it difficult to remove products from the caddy without getting them wet. A shower caddy intended to hang on a showerhead also does not permit the use of a removable showerhead. Shower caddies that are held up on the wall or other surfaces of the shower stall by suction cups usually have fixed suction cups. This means that sometimes the suction cups have to be placed over a grout line in the tile, which impedes the effectiveness of the grip of the suction cups.

In addition, over the years, the shapes of shampoo and other personal care bottles has changed while the shower organization product has not. What is needed is a shower organization product that takes into account the changing and varied shapes of personal care product bottles while at the same time allowing for a more convenient and secure placement of the actual shower organization product itself.

### SUMMARY OF THE INVENTION

The present invention relates to a solution for shower organization products. In one embodiment, the shower piece has a holder with a platform that has a suction cup on the back, a retainer attached to the front of the holder, wherein the platform has a hole, wherein the holder is designed to hold bottles without flattops upside-down. In another embodiment, the shower piece has a holder with a platform that has a suction cup on the back, two tabs on the sides of the platform of the holder, a retainer attached to the front of the holder, wherein the platform has a hole in the center of the platform, wherein the shower piece is designed to hold both flattop bottles that stand on their heads and traditional round top bottles upside-down. In another embodiment, the shower piece has a holder with a platform that has a suction cup on the back, two tabs on the sides of the platform of the holder, a retainer attached to the front of the holder, wherein the platform has a hole in the center of the platform. In this embodiment, the shower piece is able to grasp bottles with a waist while holding them upside-down and locked in place. In another embodiment, the shower piece has a holder with a platform and two small suction cups on the back, wherein the platform has a hole in the center of the platform, wherein the holder is able to hold traditional round top bottles upside-down.

In a further embodiment, the shower piece comprises a first shower piece, comprising a holder with a platform that has a suction cup on the back, a retainer attached to the front of the holder, wherein the platform has a hole; a second shower piece, comprising of a holder with a platform that has a suction cup on the back, two tabs on the sides of the platform of the holder, a retainer attached to the front of the holder, wherein the platform has a hole in the center of the platform; a third shower piece, comprising a holder with two arms and a suction cup on the back, wherein a rib is attached to the inside of the holder's arms to reinforce the structure of the organizational device; and a fourth shower piece, comprising a holder with a platform and two small suction cups on the back, wherein the platform has a hole in the center of the platform.

In a further embodiment, an article of manufacture comprising a first shower piece, which comprises a holder with a platform that has a suction cup on the back, a retainer attached to the front of the holder, wherein the platform has a hole; a second shower piece, comprising of a holder with a platform that has a suction cup on the back, two tabs on the sides of the platform of the holder, a retainer attached to the front of the holder, wherein the platform has a hole in the center of the platform; a third shower piece, comprising a holder with two arms and a suction cup on the back, wherein a rib is attached to the inside of the holder's arms to reinforce the structure of the organizational device; and a fourth shower piece, comprising a holder with a platform and two small suction cups on the back, wherein the platform has a hole in the center of the platform is shown.

A holder for shampoo or other personal care products hangs on a wall of a shower with the use of a suction cup, which is attached at the back. The holder includes a retainer for the top end of an inverted bottle that has a round top, flat top or triangular top dispensing spout and it holds the bottle in place on the shower wall by employing the use of the suction cup. The holder can be placed on anywhere on all shower wall surfaces made of tile or glass. The product inside the shampoo bottle or other personal care product bottle is drained thoroughly because the inverted position of the bottle uses gravity to empty the bottle completely.

### BRIEF DESCRIPTION OF THE DRAWINGS

FIG. 1 a depicts a ¾ frontal view of the holder showing the custom shaped hole and suction cup attached.

FIG. 1b depicts the left side view of the holder with the suction cup to the right.

FIG. 1c depicts the front view of the holder with the arc-shaped retainer at front and suction cup in the rear.

FIG. 2a depicts a ¾ frontal view of the holder showing the round hole with suction cup attached.

FIG. 2b depicts the left side view showing the side tab of the holder with the suction cup to the right.

FIG. 2c depicts the front view of the holder with the arc-shaped retainer at front and suction cup in the rear.

FIG. 3a depicts a ¾ frontal view of the holder with suction cup attached.

FIG. 3b depicts the left side view showing the side arm of the holder with the suction cup to the right.

FIG. 3c depicts the front view of the holder showing the internal ribs and suction cups in the rear.

FIG. 4a depicts a ¾ frontal view of the holder showing the hole in the platform with two suction cups attached.

FIG. 4b depicts the left side view showing the platform of the holder and the suction cups to the right.

FIG. 4c depicts the front view of the holder with the platform at the bottom and two suction cups in the rear.

### DETAILED DESCRIPTION OF THE INVENTION

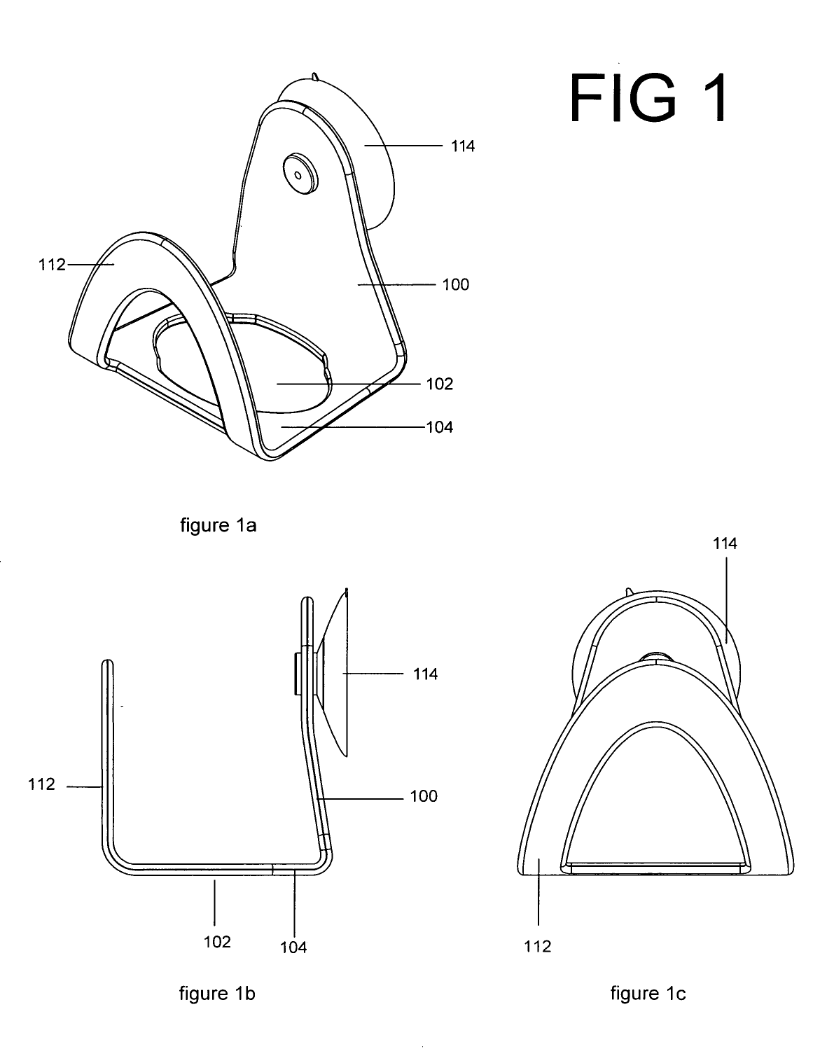

The shower piece shown in FIGS. 1a, 1b, and 1c depict one embodiment of the shower piece, comprising of a holder 100 with a platform 104 that has a suction cup 114 on the back, to support the weight of up to a 40 ounce bottle, and an arc-shaped retainer 112 on the front of the holder. The hole 102 on the platform 104 is custom designed to fit the tops of bottles that do not have flattops. For example, bottles with pointed lids fit upside down in the hole. The arc-shaped retainer 112 on the front is intended to hold a bottle in place. More specifically, figure la depicts a ¾ frontal view of the holder 100 showing the custom shaped hole and suction cup 114 attached. FIG. 1b depicts the left side view of the holder 100 with the suction cup 114 to the right. FIG. 1c depicts the front view of the holder 100 with the arc-shaped retainer 112 at front and suction cup 114 in the rear.

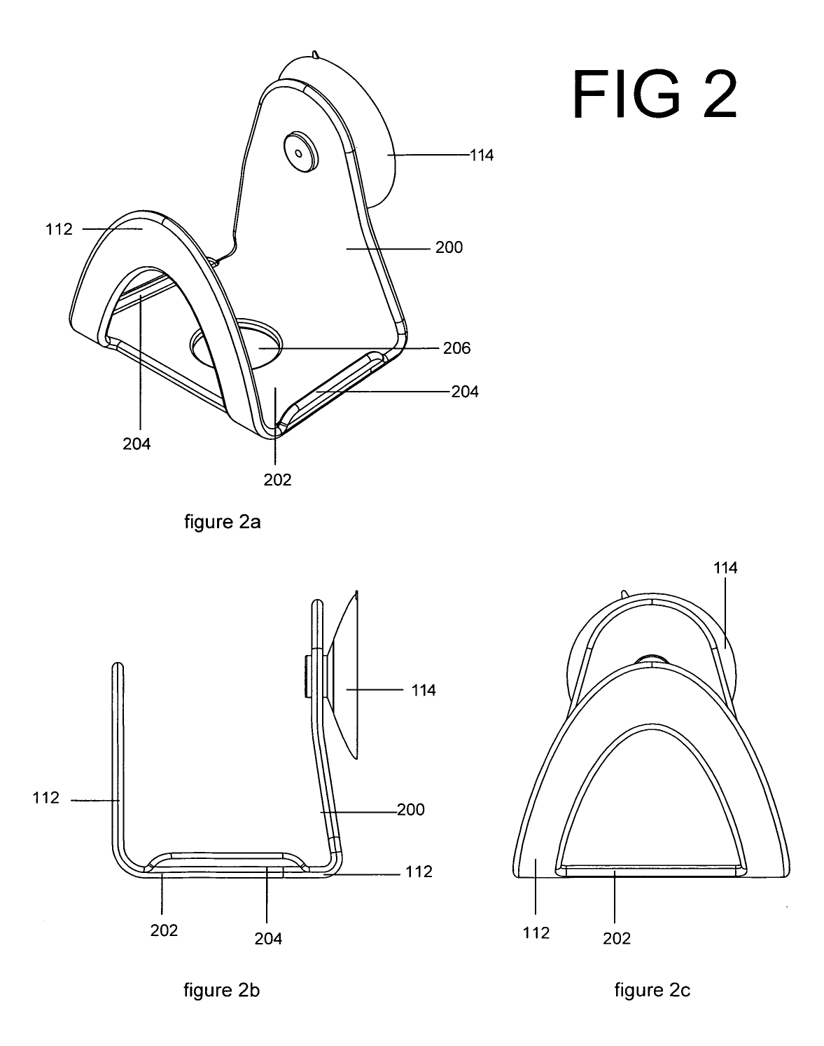

The shower piece shown in FIGS. 2a, 2b, and 2c, depict another embodiment of the shower piece comprising of a holder 200 with a platform 202 that has a suction cup 114 on the back. There are two tabs 204 on the sides of the platform of the holder that prevent the bottle from falling off of the platform. In addition, an arc-shaped retainer 112 on the front of the holder prevents bottles from tipping off of the front of the holder. The round hole 206 prevents bottles from tipping off of the front of the holder. More specifically, FIG. 2a depicts a ¾ frontal view of the holder 200 showing the round hole with suction cup 114 attached. FIG. 2b depicts the left side view showing the side tab of the holder 200 with the suction cup 114 to the right. FIG. 2c depicts the front view of the holder 200 with the arc-shaped retainer 112 at front and suction cup 114 in the rear.

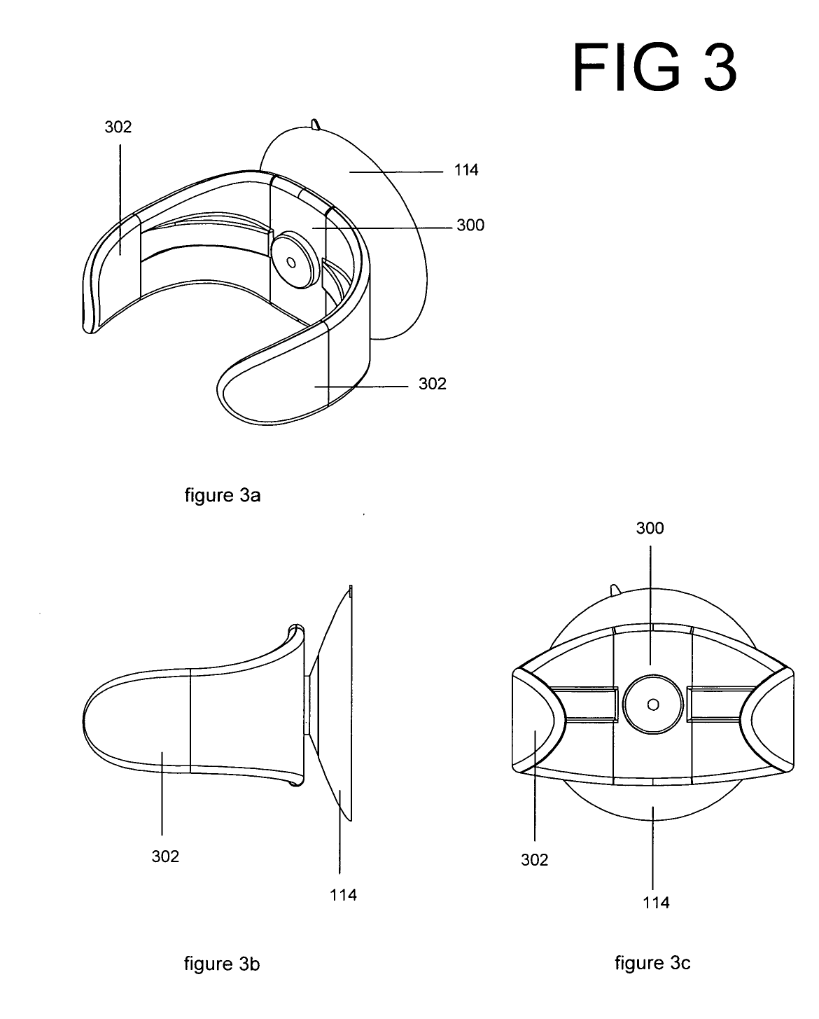

The shower piece shown in FIGS. 3a, 3b, and 3c, depict another embodiment of the shower piece comprising of a holder 300 with two arms 302 and a large suction cup 114 on the back designed to hold bottles with large volumes of up to 40 ounces. On the inside of the holder's arms 302 there is a rib to reinforce the structure. This piece is intended to hold bottles with waists upside-down. To see this holder 300, the bottle is pushed sideways, turned to the front, and then it locks in place upside-down. Specifically, FIG. 3a depicts a ¾ frontal view of the holder 300 with suction cup 114 attached. FIG. 3b depicts the left side view showing the side arm of the holder 300 with the suction cup 114 to the right. FIG. 3c depicts the front view of the holder 300 showing the internal ribs and suction cups 114 in the rear.

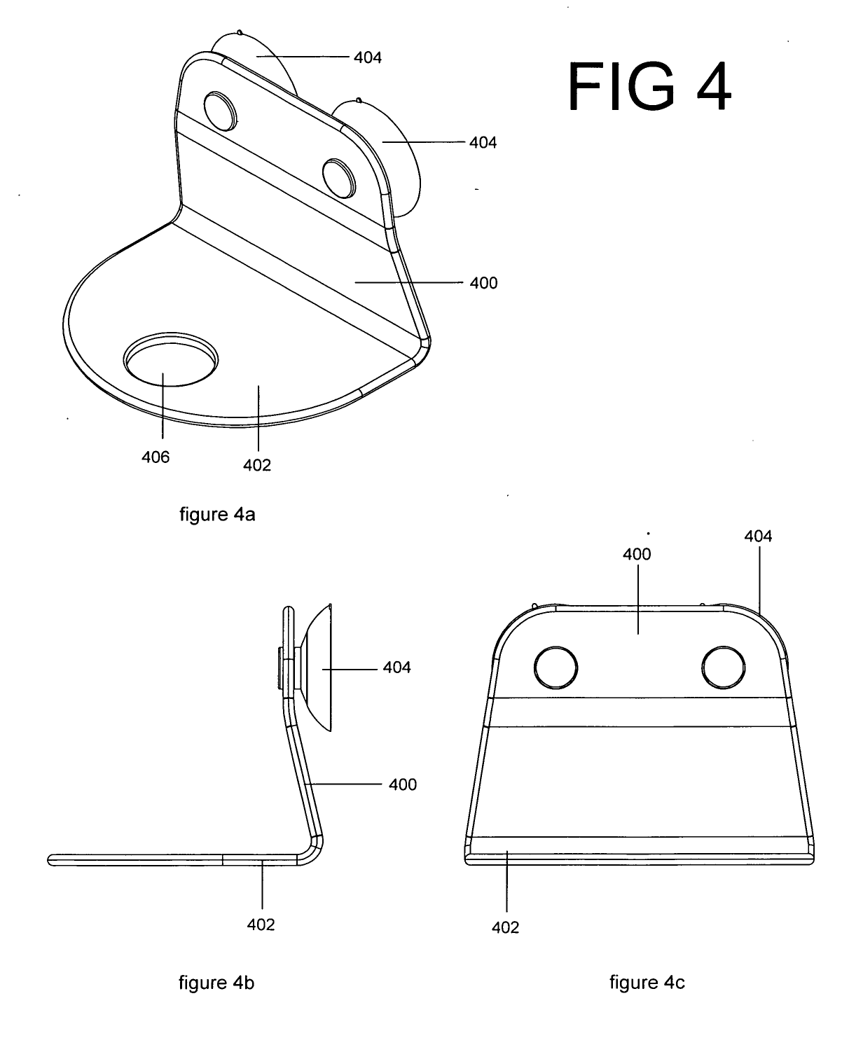

The shower piece shown in FIGS. 4a, 4b, and 4c, depict another embodiment of the shower piece comprising a holder 400 with a platform 402 and two small suction cups 404 on the back. There are no tabs or retainers on the platform so that larger bottles, those that cannot fit into the first piece, will fit into the platform. There are two suctions cups 404 so that the holder can support heavier bottles. There is a round hole 406 in the center of the platform 402 that it is designed to fit bottles with traditional round top lids. FIG. 4a depicts a ¾ frontal view of the holder 400 showing the hole in the platform with two suction cups 404 attached. FIG. 4b depicts the left side view showing the platform of the holder 400 and the suction cups 404 to the right. FIG. 4c depicts the front view of the holder 400 with the platform at the bottom and two suction cups 404 in the rear.

As shown and described above, a shower organizational device, according to FIG. 1a is depicted. As shown and described above, a shower organizational device, according to FIG. 2a, is depicted. FIG. 2b, and FIG. 2c. As shown and described above, a shower organizational device, according to FIG. 3a, FIG. 3b, and FIG. 3c is depicted. As shown and described above, a shower organizational device, according to FIG. 4a, FIG. 4b, and FIG. 4c is depicted.

The suction cups allow each product to hang from a shower wall in the location of the user's choice. Each shower organization product is designed to fit a wide range of shampoo bottles and other personal care product bottles so that they can be securely held upside-down. This allows for gravity to remove as much product as possible from the bottles. In addition, this ensures that the product does not have to be placed anywhere inconvenient such as behind or attached to the water source, over a grout line, or on the floor.

While the foregoing written description of the invention enables one of ordinary skill to make and use what is considered presently to be, the best mode thereof, those of ordinary skill will understand and appreciate the existence of variations, combinations, and equivalents of the specific embodiment, method, and examples herein.

1. A shower organizational device, comprising:
a first shower piece, comprising a holder with a platform that has a suction cup on the back, a retainer attached to the front of the holder, wherein the platform has a hole;
a second shower piece, comprising of a holder with a platform that has a suction cup on the back, two tabs on the sides of the platform of the holder, a retainer attached to the front of the holder, wherein the platform has a hole in the center of the platform;
a third shower piece, comprising a holder with two arms and a suction cup on the back,
wherein a rib is attached to the inside of the holder's arms to reinforce the structure of the organizational device; and
a fourth shower piece, comprising a holder with a platform and two small suction cups on the back, wherein the platform has a hole in the center of the platform.

2. A shower organizational device, comprising:
a shower piece, comprising a holder with a platform that has a suction cup on the back, a retainer attached to the front of the holder, wherein the platform has a hole.

3. A shower organizational device, comprising:
a shower piece, comprising of a holder with a platform that has a suction cup on the back, two tabs on the sides of the platform of the holder, a retainer attached to the front of the holder, wherein the platform has a hole in the center of the platform.

4. A shower organizational device, comprising:
a shower piece, comprising a holder with two arms and a suction cup on the back,
wherein a rib is attached to the inside of the holder's arms to reinforce the structure of the organizational device.

5. (canceled)

6. (canceled)
